(19) United States
(12) Patent Application Publication
(10) Pub. No.: US 2016/0363913 A1
(43) Pub. Date: Dec. 15, 2016

(54) Device and method for optimizing an operating point for the operation of a system

(71) Applicant: SIEMENS AKTIENGESELLSCHAFT, MUENCHEN (DE)

(72) Inventors: BERND-MARKUS PFEIFFER, WOERTH (DE); MATHIAS REBLING, NUERNBERG (DE)

(73) Assignee: SIEMENS AKTIENGESELLSCHAFT

(21) Appl. No.: 15/180,918

(22) Filed: Jun. 13, 2016

(30) Foreign Application Priority Data
Jun. 11, 2015 (EP) 15171714

(51) Int. Cl. G05B 11/01; G05B 13/02

(52) U.S. Cl. CPC G05B 11/01; G05B 13/021

(57) ABSTRACT

A device and method for optimizing an operating point to operate an automated process technology system, wherein historical process data, which is stored as temporal data sequences were recorded during operation of the system in a data memory, is evaluated To determine the operating point, where for each different operating point, which preferably correspond to stationary states of the system operation, a measure for the quality of the operation of the system is determined, the operating point from the past with the best quality is then advantageously used for the future operation of the system or is used for a subsequent further optimization.

### BACKGROUND OF THE INVENTION

1. Field of the Invention

The invention relates to a device and a method for optimization of an operating point for operation of an automated process technology system, where the operating point with the best quality that corresponds to a quality criterion is determined and displayed.

2. Description of the Related Art

The optimization of an operating point for operation of automated process technology systems is frequently performed using economic perspectives. Objectives in such cases could be to reduce the consumption of energy and/or raw materials, increase the throughput and/or the yields. Thus, by optimizing the operating point, the potential of the existing system can be better used with respect to an increase of productivity. The optimization can relate to a complete production system, a subsystem or to just one production device. The term system will be used below as a generic term for all of the above. In each system, a certain number of degrees of freedom are available with respect to the choice of operating point for the operation of the system. These will be represented by “decision variables”, typically setpoint values of closed-loop controls. The ranges of adjustment are restricted, for example, by safety regulations, by performance data of the system components and/or by product quality requirements, which appear as secondary conditions for the optimization. The target function of the optimization, frequently referred to as the quality criterion, can be defined very individually, depending on application. Frequent target functions are the maximization of the economic return of system operation per unit of time, the minimization of the specific energy consumption in relation to the production volume and/or the minimization of the load on a system component, the wear of which is associated with high costs. As well as decision variables, these target functions can also include further measurable process variables as well as external parameters, such as prices for raw materials, energy and product. The result of the optimization is a proposal for a combination of values of the decision variables that, on the one hand, is permissible in the sense of the secondary conditions and, on the other hand, promises the maximum level of success with respect to the quality criterion and thus represents an optimized operating point for the operation of the system.

A commercial operating point optimization is already known for example for the application description “SIMATIC PCS 7—MPC for fluidized bed dryers” V1.0, document ID:61926069, Siemens AG 2012. In this document, a target function that depends in a linear way on adjustment and/or closed-loop control variables of a model-based predictive controller (MPC) is defined as the quality criterion. On account of the linear dependence of the quality criterion on the decision variables, a “linear programming” (LP) optimization can be undertaken by the MPC module based on current values of the process variables.

U.S. Pat. No. 7,701,353 B1 discloses a method for optimization of an operating point, which can be referred to as sequential empirical optimization. Starting from a current operating point, the dependence of a quality criterion on decision variables is learnt by small test steps. This knowledge is subsequently used to propose further steps for changing the decision variables, which successively improve a quality calculated based on the quality criterion. The disadvantage of the conventional method is that, when the optimization is started, the starting point must be a quasi-random current operating point and the method advances in sampling steps until an expedient optimization direction is found. It can thus be necessary to initially operate the system over a comparatively long period of time, in a very uneconomic way, before the optimization method leads to economic operation.

### SUMMARY OF THE INVENTION

In view of the foregoing, it is an object of the invention to provide a device and a method for optimization of an operating point for operation of an automated process technology system, which make it possible to find a suitable operating point more quickly when the optimization is only performed or begun at a point in time before which the system has already been in operation for a certain time.

These and other objects and advantages are achieved in accordance with the invention by an optimization device an optimization method, a computer program for performing the optimization method and a corresponding computer program product with which, in order to optimize the operating point, a “historical” database, which has been recorded and stored during earlier operation of the system, is evaluated to determine which of the operating points determined based on the stored data recorded in earlier operation of the system is the best in the light of the defined quality criterion. This best operating point obtained as a result of the optimization can be used for the further operation of the system or it can serve as the starting point for a subsequent further optimization. In accordance with a further alternative, the best operating point found can be used, for example, in a subsequent further optimization to define the direction of travel for a step-by-step optimization from the current operating point in the direction of the best operating point defined based on the historical database. The fund of experience lying in the stored process data is thus advantageously now used to optimize the future stationary operating point. This enables a sequential empirical optimization, which previously, on account of the between 5 and 50 iteration steps typically required, each with harmonization processes to a new stationary state, needed a correspondingly large amount of time, to be either dispensed with entirely, when the best operating point found will be used as a future point, or the number of the iteration steps can be significantly shortened, when the best operating point is used as a new starting point or for definition of the direction of travel for a subsequent sequential optimization, for example.

In an especially advantageous embodiment of the invention, the search for the best operating point based on the historical database in the form of stored temporal data sequences for the different process variables is restricted to operating points that correspond to stationary states of the system operation. Through this, an especially good correlation of decision variables and quality criterion is achieved for the optimization. In an advantageous manner, this avoids taking into account operating points that correspond to the stationary transition processes and can occur, for example, during load changes or setpoint value jumps. During such transition processes, temporary combinations of values of the process variables can namely occur that are not possible as stationary values and do not have any reproducible relationship to the quality criterion.

An averaging of the values of the process variables within the respective time window with approximately stationary operation has the advantage that the influence of measurement noise and of random faults is reduced. This enables the reliability of the optimization result to be further improved.

Furthermore, all stationary states, in which any secondary conditions of the optimization problem are violated, such as threshold values for the product quality, can be advantageously excluded from the determination of the best operating point based on historical process data. Thus, only operating points during which, for example, the safety of the system and the product quality are guaranteed are selected.

Advantageously, measurable disturbance variables can also be taken into account with the method in accordance with the invention. Disturbance variables can be seen, for example, as input variables of a process that have a significant influence upon the operation of the system, but cannot be actively influenced. These disturbance variables are thus not available as decision variables. Typical examples for such variables are the outside temperature for systems that are out in the open, or the raw material quality, if the quality is measurable and fluctuates significantly. Ranges of values of such disturbance variables can be divided into clusters. The stationary states of corresponding operating points will be assigned to the respective clusters in accordance with the disturbance variables recorded at the same time. The search for the best operating point from a plurality of historical operating points then occur in each case within a cluster. The best operating point found is then only relevant for future operating states in which the measurable disturbance variables are located within the range of the same cluster. For operating states that belong to different clusters there can thus be different best operating points, e.g., an optimal operating point for summer operation and an optimal operating point for winter operation.

In an especially advantageous manner, the device for optimization of the operating point for the operation of an automated process technology system in accordance with the invention can be implemented in a software environment for cloud-based system monitoring. The data-based remote service “Control Performance Analytics” of Siemens AG represents such a software environment, for example. Data from customer systems is collected with the aid of software agents, aggregated and sent to a Siemens Service Operation Center, in which it is stored on a remote service computer. There it is analyzed semi-automatically with the aid of various “data analytics” software applications. If required, specially-trained experts can work highly efficiently on this database for remote service. The results of the data analysis and the optimization of the operating point can be displayed on a monitor of the remote service computer and/or provided at a Sharepoint, so that they can be viewed by the end customer, i.e., the operator of the automated process technology system, in a browser, for example.

The method for optimization of an operating point is thus preferably implemented in software or in a combination of software and hardware, so that the invention also relates to a computer program with program code instructions able to be executed by a computer for implementing the optimization method. In this context, the invention also relates to a computer program product, especially a data carrier or a storage medium, with a computer program of this type able to be executed by a computer. Such a computer program can, for example, be held in a memory of a control system of an automated process technology system or loaded into the automated process technology system, so that during operation of the system the optimization method is performed automatically, or the computer program can be held for a cloud-based operating point optimization in a memory of a remote service computer or is able to be loaded into the remote service computer. In addition, the computer program can also be held in a computer connected to the control system and the remote service computer that communicates via networks with the two other systems.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention as well as embodiments and advantages are explained in greater detail below with reference to the drawing, in which an exemplary embodiment of the invention is shown, in which:

FIG. 1 is a schematic block diagram of an automated process technology system; and

FIG. 2 is a flowchart of the method in accordance with the invention.

### DETAILED DESCRIPTION OF THE EXEMPLARY EMBODIMENTS

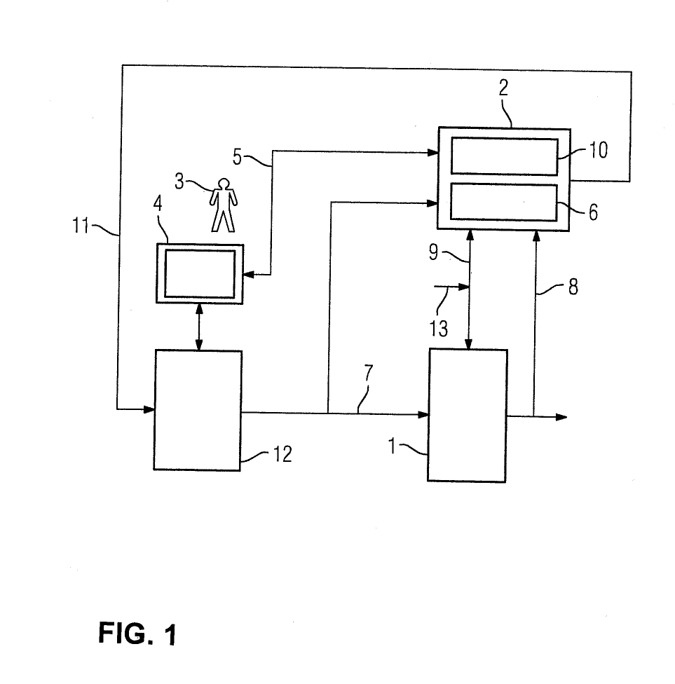

To illustrate the invention, FIG. 1 shows a block diagram with an automated process technology system 1, of which the optimal operating point is found based on historical process data via a device 2. In the exemplary embodiment shown, the system 1 involves a single-stage fluidized bed dryer for High Density Polyethylene (HDPE) powder, as is already known from the application description cited above. As regards a more detailed presentation of the dryer, the reader is therefore referred to the application description. In the automated process technology system 1, an educt, a moist material with a certain water content, is then fed into the dryer from above via a cell wheel lock. In this case, the mass flow of the educt is controlled via a closed-loop control by influencing the rotational speed of the cell wheel lock. Fresh air is sucked in with a compressor and heated with hot steam in a heat exchanger. The mass flow of the hot air is controlled via a further closed-loop controller by influencing the rotational speed of the compressor. The temperature of the hot air is controlled in a cascade controller with an external closed-loop control via a follow-up control by influencing a valve in a steam pipe of the hot steam. The dried product obtained via the dryer is sucked out at the bottom, where the moisture and the temperature of the product are measured.

A commercial yield J of the operation of the automated process technology system 1 is pre-specified as the quality criterion by an operator 3 by making an entry at an operator unit 4 and is transferred via a signal connection 5 to the device 2 and stored there. In this case the objective, with the aid of the device 2, is to automatically find the commercially optimal operating point for each throughput while adhering to secondary conditions for the product quality. Values of various process variables during earlier operation of the automated process technology system 1 are recorded as historical process data and for each process variable a temporal data sequence that corresponds to measured values obtained in the measurement window is stored in a data memory 6. In accordance with a signal connection 7, the process variables can involve input variables of the automated process technology system 1 and also, in accordance with a signal connection 8, can involve output variables of the automated process technology system 1. In a corresponding manner, temporal data sequences of disturbance variables 13 are also measured and stored, as is indicated in FIG. 1 by a signal connection 9.

To find the optimal operating point, there is no forward sampling from a “random” current state, such as stumbling around in the dark, until an optimization direction can be found, but the historical process data held in the data memory 6 is initially evaluated by an evaluation device 10, in order to determine which of the previously found operating points is the best in the light of the defined quality criterion. On the one hand, this point is notified to the operator 3 on the operator unit 4 and, on the other hand, in accordance with a signal connection 11, is conveyed to a selection device 12. The operator 3 can now choose whether to accept the best operating point determined by the device 2 directly as the new operating point for the future operation of the system 1 by corresponding setting of the selection device 12 or whether to select the proposed best operating point as the starting point for a subsequent further optimization or for definition of a direction of travel for a subsequent further optimization starting from the current operating point, which can be executed in accordance with the known sequential empirical optimization method, for example.

To find the best operating point based on the historical process data stored in the data memory 6, in accordance with an exemplary embodiment, the procedure is as follows:
A quality criterion is initially defined, which the operator 3 pre-specifies via the operating unit 4 of the device 2 for example. This can be performed in the same way as the conventional sequential empirical optimization. Along with the decision variables, any given measurable process variables can occur in the quality criterion. The mathematical form of the quality criterion is not restricted. Additional parameters, such as prices for raw materials or energy, can be entered by the operator 3 or loaded automatically from external sources.

In the next step, the historical database for determining the operating points, which will be included in the determination of the best operating point, is searched for stationary states, and in each case, a time window identifying the state is determined. A method known from WO 2008/145154 A1, for example, or any other method for determining a stationary state in temporal sequences of process data can be employed for this purpose.

In a further step, average values of all relevant process variables are calculated to determine the operating points over the respective sections of the data sequences corresponding to each other in time that correspond to the respective time window of the stationary state of an operating point.

All stationary states in which any secondary conditions of the optimization problem are violated, e.g., in which threshold values for the product quality are not adhered to, are subsequently excluded from the determination of the best operating point.

For all operating points thus obtained, in which the secondary conditions are fulfilled, the quality criterion is evaluated, i.e., a measure for the quality of the operation of the system at the different operating points is calculated.

With a suitable search method the best operating point, i.e. the operating point with the best quality with respect to the quality criterion is determined.

In this way, the best operating point is determined, which has ever been run on the automated process technology system 1 in the observed past.

Disturbance variables 13, which exert an influence on the operation of the automated process technology system 1, are additionally recorded and data sequences of the disturbance variables 13 corresponding in time to the data sequences of the process variables are stored in the data memory 6. Disturbance variables 13 that cannot be actively influenced are not available as decision variables. In the example of an automated process technology system 1 with a fluidized bed dryer, the moisture of the educt, the moisture of the sucked-in fresh air and/or its mass throughput are taken into account as disturbance variables, provided they are measured and change so much during operation that they have a significant influence on the behavior of the system at the respective operating point. If the automated process technology system 1 is operated with different sorts of raw materials with different moisture content, different best operating points can therefore be produced for different sorts of raw materials as the result of the optimization. If the automated process technology system 1 is operated with fresh air from the environment, then different best operating points can also be produced for different weather conditions with high or low air humidity. Furthermore, there can be different best operating points, e.g., for part load operation and full-load operation, when the automated process technology system 1 can be operated with different mass throughput.

In the concrete example of an automated process technology system 1 with a fluidized bed dryer, the setpoint values for hot air temperature and hot air mass flow are available as decision variables for the operating point, for example. A given drying task can namely be solved in principle with a smaller amount of hotter air or with a larger amount of slightly less hot air. The question is, which combination is optimal from the commercial point of view. As secondary conditions, the requirements for product quality are to be fulfilled, which in this example are specified in the form of permissible ranges for product moisture and product temperature.

To determine the operating points, non-stationary dynamic processes are initially sorted out of the historical database, e.g., start-up and shut-down processes, load change or setpoint value jumps. From the sections of the temporal data sequences that remain as stationary states, the only states examined in greater detail are those in which all secondary conditions are fulfilled, i.e., for which the product quality lies within the specifications with respect to moisture content and temperature. Further secondary conditions, e.g., the operation of the drive motors in the permitted performance range, are adhered to in any event by the available automation. Reliably finding a suitable best operating point for the subsequent operation is thus insured overall.

For the optimization of the economic yield J the costs for raw materials and energy as well as the revenue for the product at the different operating points are considered. Both the thermal energy consumption, which is determined by the amount of hot steam for heating the supply air, and also the power consumption for hot air fan and cell wheel lock contribute to the energy costs. In the calculation of the product revenue, attention is also paid to the mass of the product reducing through the drying process and the mass flow is advantageously merely measured on the inlet side. To this end, the product mass flow is calculated indirectly from the educt mass flow. The economic yield J as the quality criterion to be maximized can be calculated as the difference between revenue and the sum of the costs associated with the operation of the system. Costs and profit are expressed by simple formulae and are employed in the target function, i.e., the quality criterion, where all external parameters, such as raw materials and energy prices, as well as apparatus data, are stored with figures. The quality criterion is evaluated for each operating point determined on the basis of the historical process data.

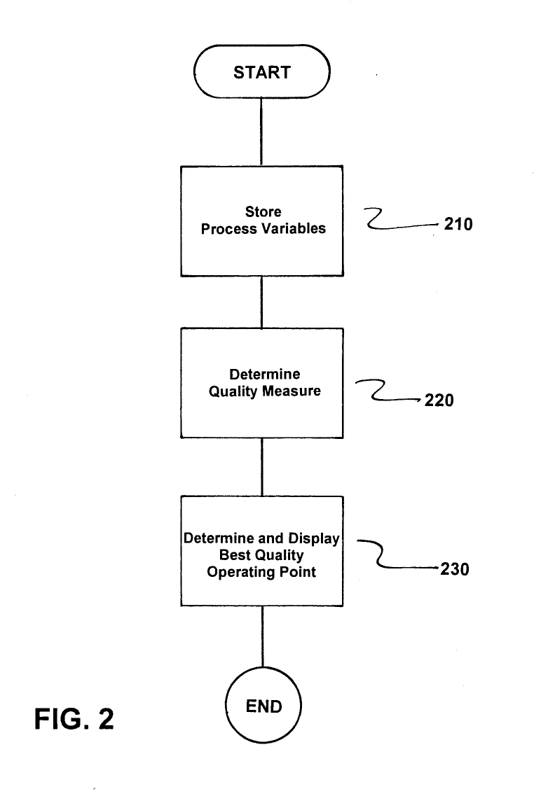

FIG. 2 is a flowchart of a method for optimizing an operating point to operate an automated process technology system (1). The method comprises storing in a data memory (6) of a data sequence recorded during operation of the automated process technology system (1) for each of a number of process variables, as indicated in step 210.

Next, a measure for the quality of the operation of the system (1) at each different operating point via an evaluation device (10) is determined based on a predetermined quality criterion, as indicated in step 220. In accordance with the method of the invention, each operating point is determined based on sections of data sequences corresponding to one another in time. The operating point with the best quality then determined and displayed.

The operating point with the best quality is now determined and displayed, as indicated in step 230.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A device for optimizing an operating point to operate an automated process technology system, comprising:
a data memory in which, for a number of process variables, a temporal data sequence recorded during operation of the system is stored, and
an evaluation device for determining a measure for a quality of the operation of the system at each different operating point of a plurality of operating points based on a predetermined quality criterion;
wherein each operating point of the plurality of operating points is determined based on sections of data sequences corresponding to each other in time;
wherein the device is configured to determine and display the operating point with a best quality.

10. The device as claimed in claim 9, wherein the evaluation device is configured to select the operating points for which each measure of the quality are determined, and to search through stored data sequences for sections corresponding temporally to one another, which at least approximately correspond to stationary states of the operation of the system.

11. The device as claimed in claim 10, wherein the evaluation device is further configured to calculate an average value of the data sequences of each section of the sections corresponding in time to one another and to determine the operating points based on the calculated average values.

12. The device as claimed in claim 9, wherein operating points are excludable by the evaluation device from the determination of the operating point with the best quality when a predetermined criterion is unfulfilled for these operating points.

13. The device as claimed in claim 9, wherein a data sequence of at least one disturbance variable is additionally storable in the data memory;
wherein operating points are assignable by the evaluation device to predetermined clusters in accordance with values of the disturbance variables for a respective operating time; wherein the predetermined clusters each correspond to a predetermined range of values of the disturbance variable; and
wherein an operating point with the best quality is determinable by the evaluation device for each different cluster of the predetermined clusters.

14. A method for optimizing an operating point to operate an automated process technology system, the method comprising:
storing in a data memory of a data sequence recorded during operation of the automated process technology system for each of a number of process variables;
determining a measure for the quality of the operation of the system at each different operating point via an evaluation device based on a predetermined quality criterion, each operating point being determined based on sections of data sequences corresponding to one another in time; and
determining and displaying the operating point with the best quality.

15. A computer program having program code instructions which, when executed by a computer, causes optimization of an operating point for operation of an automated process technology system, the computer program instructions comprising:
program code for storing in a data memory of a data sequence recorded during operation of the automated process technology system for each of a number of process variables;
program code for determining a measure for the quality of the operation of the system at each different operating point via an evaluation device based on a predetermined quality criterion, each operating point being determined based on sections of data sequences corresponding to one another in time; and
program code for determining and displaying the operating point with the best quality.

16. A non-transitory computer program product encoded with a computer program which, when executed on a computer, causes optimization of an operating point for operation of an automated process technology system, the computer program comprising:
program code for storing in a data memory of a data sequence recorded during operation of the automated process technology system for each of a number of process variables;
program code for determining a measure for the quality of the operation of the system at each different operating point via an evaluation device based on a predetermined quality criterion, each operating point being determined based on sections of data sequences corresponding to one another in time; and
program code for determining and displaying the operating point with the best quality.

17. The non-transitory computer program product, wherein the non-transitory computer program product comprises a data carrier or storage medium.
